(19) United States
(12) Patent Application Publication
(10) Pub. No.: US 2009/0185247 A1
(43) Pub. Date: Jul. 23, 2009

(54) HOLOGRAPHIC DATA STORAGE MEDIUM, AND METHOD AND APPARATUS FOR RECORDING/REPRODUCING HOLOGRAPHIC DATA TO/FROM THE SAME

(75) Inventors: Taek-seong Jeong, Suwon-si (KR); Jae-cheol Bae, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/205,039

(22) Filed: Sep. 5, 2008

(30) Foreign Application Priority Data
Jan. 21, 2008 (KR) 2008-6233

(51) Int. Cl. G03H 1/26; G03H 1/02

(52) U.S. Cl. 359/28; 359/3; 359/22; 359/15

(57) ABSTRACT

A holographic data storage medium, and a method and an apparatus for recording/reproducing holographic data by using the medium includes a substrate; manifold reflective layer between which a part of a signal beam is capable of being reflected at least one time and then being emitted from the manifold reflective layer; and a holographic recording layer in which a plurality of information layers are capable of being formed in a depth direction of the holographic recording layer, wherein interference patterns of a rest of the signal beam and a reference beam constitute each of the plurality of information layers.

### CROSS-REFERENCE TO RELATED APPLICATIONS

This application claims the benefit of Korean Patent Application No. 2008-6233, filed on Jan. 21, 2008 in the Korean Intellectual Property Office, the disclosure of which is incorporated herein in its entirety by reference.

### BACKGROUND OF THE INVENTION

1. Field of the Invention

Aspects of the present invention relate to a holographic data storage medium, a method and apparatus for recording/reproducing holographic data to/from the holographic data storage medium, and more particularly, to a holographic data storage medium in which layers on which data is recorded can be distinguished from each other when multilayer recording is performed, and a method and an apparatus for recording/reproducing holographic data to/from the holographic data storage medium.

2. Description of the Related Art

Recently, information storage technology using holograms has attracted much attention. An information storage method using holograms stores information in the form of an optical interference pattern in a polymer material or an inorganic crystal that is sensitive to light. The optical interference pattern is formed by using two laser beams exhibiting an interference feature. That is, the interference pattern, formed as a reference beam and a signal beam from different paths interfere with each other, causes a chemical or a physical change on a photosensitive storage medium, thereby recording information. In order to reproduce the information from a recorded interference pattern, the reference beam, similar to the one used for recording, is emitted onto the interference pattern recorded to the storage medium, and thus, the reference beam causes diffraction due to the interference pattern so that the signal beam is reproduced and the information is reproduced.

Holographic information storing technology includes a volume holographic method that records/reproduces information in units of pages by using volume holography and a micro-holographic method that records/reproduces information in units of single bits by using micro-holography. The volume holographic method has an advantage in that a large amount of information can be processed at the same time. However, the method has a problem in that it is difficult to commercialize an information storage device for general consumer use because an optical system needs to be very precisely adjusted.

In the micro-holographic method, a signal beam and a reference beam are made to interfere with each other at a focus, and by moving this interference pattern on the plane of a storage medium, a plurality of patterns are recorded to form a holographic recording layer, thereby recording information. By emitting a reference beam for reproduction to the interference pattern, the recorded information can be reproduced. Since the holographic recording layer has a volume, a plurality of information layers can be formed in a depth direction of the holographic recording layer, wherein information is recorded in the form of the interference pattern in the information layers. That is, by changing focuses of the signal beam and the reference beam in the depth direction of the holographic recording layer, the formed information layers can be used to record information thereon, thereby three-dimensionally recording information to the holographic recording layer.

### SUMMARY OF THE INVENTION

Aspects of the present invention includes a holographic data storage medium in which a holographic recording layer has formed information layers that can be distinguished from each other, and has a volume, and a method and an apparatus for recording/reproducing holographic data by using the holographic data storage medium.

According to an aspect of the present invention, there is provided a holographic data storage medium includes: a substrate; a manifold reflective layer between which a first part of a signal beam is capable of being reflected at least one time and then being emitted from the manifold reflective layers; and a holographic recording layer in which a plurality of information layers are capable of being formed in a depth direction of the holographic recording layer, wherein interference patterns of a reference beam and a second part of the signal beam constitute each of the plurality of information layers.

According to another aspect of the present invention, there is provided an apparatus to record/reproduce holographic data by using a holographic data storage medium including a substrate, a manifold reflective layer between which a first part of a signal beam is capable of being reflected at least one time and then being emitted from the manifold reflective layer, and a holographic recording layer in which a plurality of information layers are capable of being formed in a depth direction of the holographic recording layer, wherein interference patterns of a reference beam and a second part of the signal beam constitute each of the plurality of information layers, the apparatus including: an optical pickup to detect a signal of the signal beam that is incident on the holographic data storage medium, and is reflected in the manifold reflective layer in order to be emitted from the holographic storage medium, wherein the apparatus detects respective locations of the plurality of information layers from the signal detected by the optical pickup.

According to another aspect of the present invention, a method of recording/reproducing holographic data by using a holographic data storage medium including a substrate, a manifold reflective layer between which a first part of a signal beam is capable of being reflected at least one time and then being emitted from the multi-reflective layers, and a holographic recording layer in which a plurality of information layers are capable of being formed in a depth direction of the holographic recording layer, wherein interference patterns of a reference beam and a second part of the signal beam constitute each of the plurality of information layers, the method including: detecting respective locations of the plurality of information layers from a signal of a signal beam that is incident on the holographic data storage medium and is reflected in the manifold reflective layer so as to be emitted from the holographic storage medium.

According to an aspect of the present invention, a holographic data storage medium for use with a holographic recording/reproducing apparatus, includes: a substrate; a first reflective layer to reflect and to transit components of a light beam according to corresponding polarizations of the components of the light beam, and formed over the substrate; a second reflective layer to reflect the transmitted component of the light beam, and formed on the substrate; a space layer to transmit the transmitted component of the light beam, and formed between the first and second reflective layers; and a holographic recording layer capable of being formed into a plurality of information layers containing interference patterns based on the reflected component of the light beam, and formed on the second reflective layer, wherein the plurality of information layers are generated in a depth direction of the holographic recording layer based on a detected strength of the transmitted component of the light beam.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a perspective cross-sectional view of a holographic data storage medium according to an aspect of the present invention;

FIG. 2 illustrates optical paths of a reference beam and a signal beam when data is recorded to the holographic data storage medium of FIG. 1, according to an aspect of the present invention;

FIGS. 3A through 3C are views for distinguishing between information layers in a holographic recording layer by using the signal beam, according to an aspect of the present invention;

FIG. 4 illustrates S-curves of a signal beam for distinguishing between information layers, according to an aspect of the present invention;

FIG. 5 is a cross-sectional view of a holographic data storage medium according to another aspect of the present invention; and

FIG. 6 is a structural view of a holographic data recording/reproducing apparatus according to an aspect of the present invention.

### DETAILED DESCRIPTION OF THE EMBODIMENTS

Reference will now be made in detail to aspects of the present invention, examples of which are illustrated in the accompanying drawings, wherein like reference numerals refer to the like elements throughout. The aspects are described below in order to explain the present invention by referring to the figures. In the drawings, thicknesses of layers and regions are exaggerated for clarity.

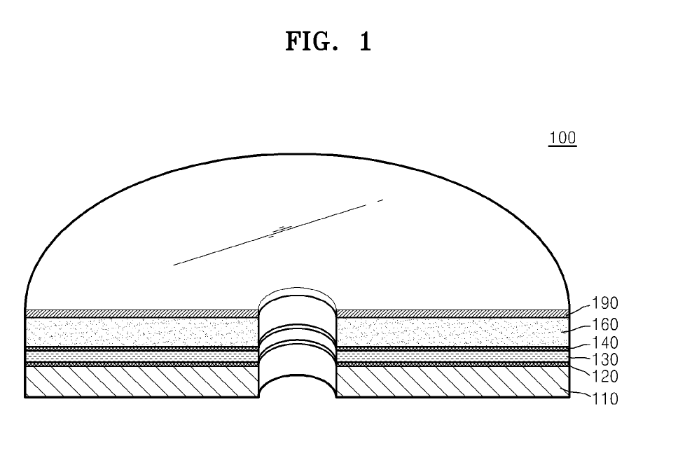

FIG. 1 is a perspective cross-sectional view of a holographic data storage medium 100 according to an aspect of the present invention. Referring to FIG. 1, the holographic data storage medium 100 is a reflective type storage medium including a substrate 110, a first reflective layer 120, a space layer 130, a second reflective layer 140, a holographic recording layer 160, and a cover layer 190, which are sequentially stacked For convenience of description, with respect to the substrate 110, a side towards the cover layer 190 will be referred to as an upper portion, and a side away from the cover layer 190 will be referred to as a lower portion. In aspects of the present invention, the first reflective layer 120, the space layer 130, and the second reflective layer 140 may be referred to as a manifold reflective layer.

The substrate 110 is a support provided to maintain the shape of the holographic data storage medium 100, such as a disk shape, and may be formed of a polycarbonate resin, an acrylic resin, or the like. The cover layer 190 protects the holographic recording layer 160, and maintains the shape of the holographic recording layer 160 that may not be formed of solid matter. An anti-reflective layer (not shown),to prevent or reduce light from being reflected by a surface of the cover layer 190, may be further formed on the cover layer 190. When in use, a signal beam and a reference beam are incident on the holographic recording layer 160 via the cover layer 190, thereby recording data.

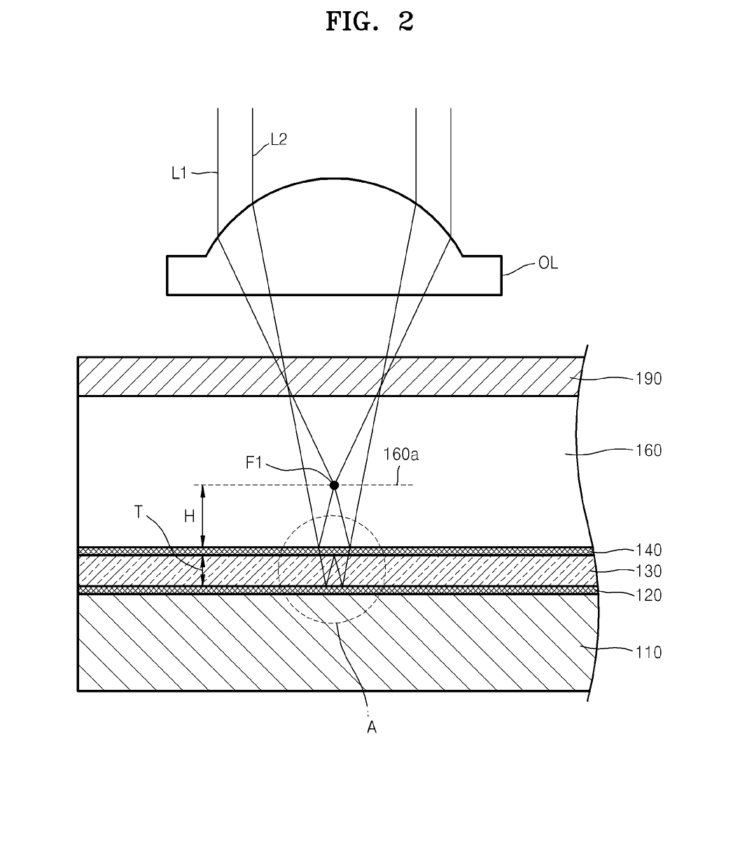

The holographic recording layer 160 is formed of photosensitive material, such as a photo polymer or a thermoplastic material, on which information can be recorded by micro holograms (i.e., a recording mark) generated by an interference pattern between a signal beam and a reference beam. In general, the refractive index of a photosensitive material changes if light is absorbed in proportion to the strength of the light. The holographic recording layer 160 has a volume. In the holographic recording layer 160, recording marks generated by the interference pattern may be formed to constitute a plurality of layers in a vertical direction. Accordingly, the layers on which information is recorded will be referred to as information layers (160a of FIG. 2).

The photosensitive material of the holographic recording layer 160 may have a nonlinear characteristic in which the photosensitive material has a predetermined response threshold in terms of a strength of light and responds only to light that is stronger than the predetermined response threshold. When the material used for forming the holographic recording layer 160 has the nonlinear characteristic, and the holographic recording layer 160 includes the information layers 160a formed in a depth direction of the holographic recording layer 160, the strength (or clarity) of the interference pattern rapidly weakens as the distance from a focus location increases, and thus, such a characteristic is used in performing dense multilayer recording.

The first and second reflective layers 120 and 140 are spaced apart from each other by a predetermined interval, and may be formed of a circular polarization selective material that reflects a first circular polarization beam and transmits a second circular polarization beam, where the polarization directions of the first and second circular polarizations are orthogonal to each other. However, the first and second reflective layers 120 and 140 do transmit a part of the reflected first circular polarization beam. For example, using a right circular polarization beam as an example, the first and second reflective layers 120 and 140 reflect 90% of the right circular polarization beam and transmit 10% of the right circular polarization beam. In this case, a part of the right circular polarization beam incident on the second reflective layer 140 is transmitted through the second reflective layer 140, and is then reflected between the first and second reflective layers 120 and 140 at least one time to be emitted to the cover layer 190 via the second reflective layer 140.

Furthermore, the first and second reflective layers 120 and 140 maintain the polarization direction of the reflected first circular polarization beam. For example, the first and second reflective layers 120 and 140 transmit a left circular polarization beam, and reflect a right circular polarization beam while maintaining the polarization direction of the right circular polarization beam. The first and second reflective layers 120 and 140 may be formed of a cholesteric liquid crystal of a liquid crystal film that may be in a liquid crystal state or a hardened state. The cholesteric liquid crystal of the first and second reflective layers 120 and 140 has a structure in which a director of liquid crystal molecules is twisted in a spiral. In this regard, the cholesteric liquid crystal almost reflects a circular polarization beam polarized in the direction of the spiral and transmits a circular polarization beam polarized in a direction opposite to the direction of the spiral. Then, the two circular polarization beams of which polarization directions are orthogonal to each other can be separated from each other, and the state of the reflected circular polarization beam can be maintained in a state of initial circular polarization.

In this aspect of the present invention, the first and second reflective layers 120 and 140 are formed of a circular polarization selective material, but the aspects of the present invention are not limited thereto. For example, the first and second reflective layers 120 and 140 may be formed as a general reflective layer, and the polarization direction of a reflected circular polarization beam can be changed. In such a case, the first and second polarization beams are incident on the cover layer 190 while maintaining the polarization directions of the first and second circular polarization beams.

Referring back to FIG. 1, the space layer 130 is a layer to secure a space between the first and second reflective layers 120 and 140, and is formed of a transparent medium. The refractive index of the space layer 130 may be the same as that of the holographic recording layer 160, but aspects of the present invention are not limited thereto. For convenience of description, assuming that the refractive index of the space layer 130 is the same as that of the holographic recording layer 160, a thickness (T of FIG. 2) of the space layer 130 may correspond to an interval between the information layers (160a of FIG. 2) that may be formed in the holographic recording layer 160, as described below. In this case, by forming the space layer 130 having the thickness T that is smaller than at least ½ of the thickness of the holographic recording layer 160, multilayer recording can be performed on the holographic recording layer 160. If the refractive index of the space layer 130 is greater than that of the holographic recording layer 160, the thickness T of the space layer 130 may be smaller than the interval between the information layers (160a of FIG. 2) that may be formed in the holographic recording layer 160.

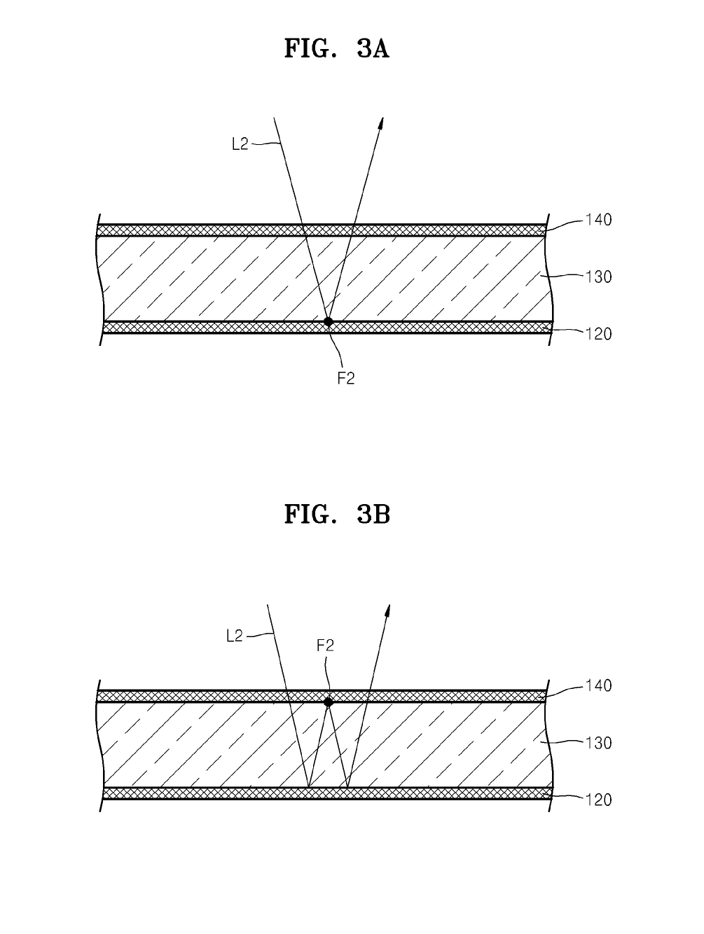

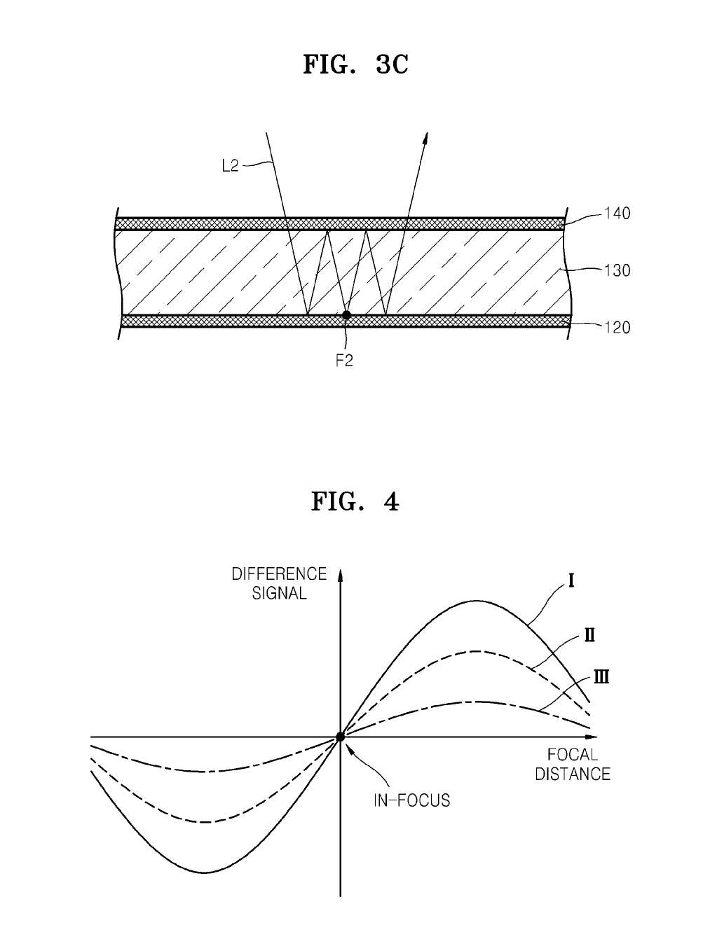

FIG. 2 illustrates optical paths of a reference beam L1 and a signal beam L2 when data is recorded to the holographic data storage medium 100 of FIG. 1, according to an aspect of the present invention. FIGS. 3A through 3C are views for distinguishing between information layers in a holographic recording layer by using the signal beam L2, according to an aspect of the present invention. FIG. 4 illustrates S-curves of a reflected signal beam for distinguishing between the information layers, according to an aspect of the present invention.

First, data is recorded to the holographic data storage medium 100 as follows. Referring to FIG. 2, the reference beam L1 and the signal beam L2 are both incident on the holographic data storage medium 100 via an objective lens OL. The reference beam L1 is incident on the cover layer 190, and is focused on a focus F1. The signal beam L2 is reflected by the second reflective layer 140, and is focused on the focus F1. Since the first and second reflective layers 120 and 140 maintain the polarization state of the signal beam L2 that is reflected by the second reflective layer 140, the reference beam L1 and the signal beam L2 that are incident have circular polarization components orthogonal to each other. If the first and second reflective layers 120 and 140 change the polarization state of the signal beam L2 that is reflected like in the case of a general reflective layer, an optical system needs to be designed so that the reference beam L1 and the signal beam L2 that are incident have circular polarization components that are the same as each other. That is, the optical system is designed so that the reference beam L1 and the signal beam L2, which proceed in opposite directions to each other to overlap, have circular polarization components orthogonal to each other. In this case, the polarization axes of the reference beam L1 and the signal beam L2 rotate around the same optical axis in the same direction. Accordingly, the reference beam L1 and the signal beam L2 interfere with each other.

Likewise, as the reference beam L1 and the signal beam L2 proceed in opposite directions to overlap, interference patterns (i.e., micro holograms) are formed. Since the shape of the interference pattern varies according to the modulated state of the signal beam L2, or the modulated states of the reference beam L1 and the signal beam L2, the interference patterns can contain information. The holographic data storage medium 100 uses a micro holography method in which a single bit of data is contained in each interference pattern constituting one recording mark. The interference patterns are recorded along tracks on the same plane so as to constitute one of the information layers 160a in the holographic recording layer 160. As a focus location varies in a depth direction of the holographic recording layer 160, the information layers 160a are stacked in the depth direction of the holographic recording layer 160.

Next, information regarding a location of the information layer 160a, that is, a height H of the information layer 160a is obtained as follows with reference to FIGS. 3A to 3C. As described above, the second reflective layer 140 almost entirely reflects the first circular polarization beam and transmits the second circular polarization beam, where the first and second polarization beams are orthogonal to each other. That is, the reference beam L1 is transmitted, and the signal beam L2 is almost entirely reflected. However, an actual material used for forming the second reflective layer 140 transmits a part of the signal beam L2.

In this aspect, the signal beam L2, which is partially reflected, is used. For example, a part of the signal beam L2 that is transmitted through the second reflective layer 140 is reflected by the first reflective layer 120, is again transmitted through the second reflective layer 140 (from the other side), and is emitted from the cover layer 190 (not shown), as illustrated in FIG. 3A. At this time, when the focus (F2 of FIG. 3A) of the transmitted part of signal beam L2 is formed on the first reflective layer 120, the rest of the signal beam L2 that is reflected by the second reflective layer 140 may be focused in the holographic recording layer 160. In addition, a focus F2 of the part of the signal beam L2 that is transmitted through the second reflective layer 140 and a focus F1 of the rest of the signal beam L2 that is reflected by the second reflective layer 140 are positioned such as mirror images to each other.

For convenience of description, assuming that the refractive index of the space layer 130 is the same as that of the holographic recording layer 160, the height H of the information layer 160a, on which a focus of the part of the signal beam L2 that is reflected by the second reflective layer 140 is focused, is integer times an interval between the first and second reflective layers 120 and 140, that is, integer times of the thickness T of the space layer 130. In FIG. 3A, the height H of the information layer 160a is the thickness T of the space layer 130. In FIG. 3B, the height H of the information layer 160a is two times of the thickness T of the space layer 130. In FIG. 3C, the height H of the information layer 160a is three times of the thickness T of the space layer 130.

The part of the signal beam L2 that is transmitted through the second reflective layer 140 may be reflected by the first reflective layer 120 and/or the second reflective layer 140, and then may proceed back along the same optical path so as to be detected by an optical pickup. Thus, a signal of the signal beam L2 that is detected by the optical pickup may be an S-curve signal, as illustrated in FIG. 4. That is, if an optical system of the optical pickup is optically optimized when a part of the signal beam L2 that is transmitted through the second reflective layer 140 is focused on the first reflective layer 120 or the second reflective layer 140, a light spot of a light beam that is not focused on the first reflective layer 120 or the second reflective layer 140 may deviated from a photodetector. In particular, when an astigmatism lens is positioned in front of a quad-detector, focus error signals form S-curves. A method of detecting a focus error signal by using the astigmatism lens and the quad-detector is well known to one of ordinary skill in the art, and thus, its description will be omitted.

Since the second reflective layer 140 almost entirely reflects components of the signal beam L2 but transmits a part of the components of the signal beam L2, when the signal beam L2 is repeatedly reflected between the first and second reflective layers 120 and 140, the strength of the signal beam L2 that is detected gradually weakens. For example, in the S-curves illustrated in FIG. 4, a curve “I” is related to the case where the signal beam L2 is reflected one time, as illustrated in FIG. 3A, a curve “II” is related to the case where the signal beam L2 is reflected three times, as illustrated in FIG. 3B, and a curve “III” is related to the case where the signal beam L3 is reflected five times, as illustrated in FIG. 3C.

Accordingly, using the signal beam L2 that is detected by the optical pickup, a location of the information layer 160a on which the signal beam L2 is focused can be determined. Thus, the height of the information layer 160a can be determined by using information of focal location of the signal beam L2. That is, by using the focus error signals of the signal beam L2, each of the information layers 160a can be distinguished from each other. FIG. 4 discloses an aspect when there are three information layers 160a. However, aspects of the present invention are not limited in the number of the information layers 160a in the holographic recording layer 160.

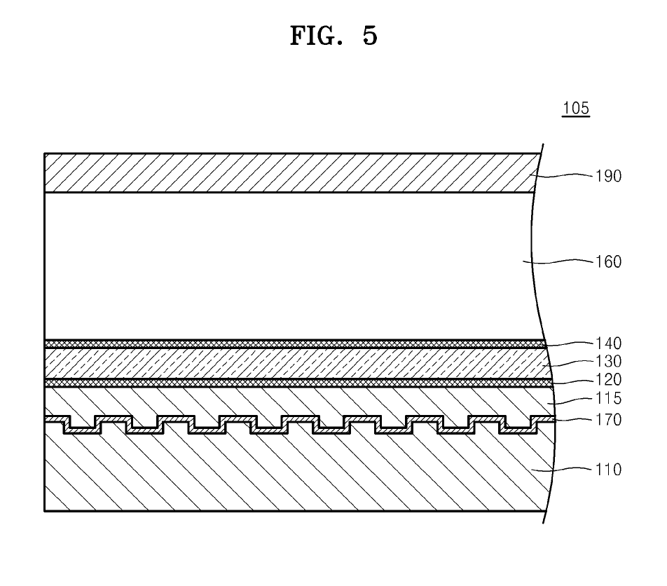

FIG. 5 is a cross-sectional view of a holographic data storage medium 105 according to another aspect of the present invention. The holographic data storage medium 105 includes a servo layer 170, a buffer layer 115, a first reflective layer 120, a space layer 130, a second reflective layer 140, a holographic recording layer 160, and a cover layer 190, which are sequentially stacked on a substrate 110.

The servo layer 170 is a layer on which servo information is recorded, and may be formed during manufacturing of the holographic data storage medium 105. As described below, when a separate servo optical system is used, the servo layer 170 functions as a mirror with respect to a wave of a servo beam, and the rest of the layers (i.e., the first and second reflective layers 120 and 140, the space layer 130, the holographic recording layer 160, and the cover layer 190) may be transparent with respect to the wave of the servo beam.

The buffer layer 115 is interposed between the servo layer 170 and the first reflective layer 120, and may be formed of a material that is transparent or absorbs a light beam having a wavelength for recording/reproducing operations. The buffer layer 115 is formed so that patterns of servo information are filled up, wherein the patterns are formed on the servo layer 170, and thus, the first reflective layer 120 is formed flat or planar.

The holographic data storage medium 105 is substantially the same as the holographic data storage medium 100 except that the separate servo layer 170 is used. Thus, the same reference numerals in FIGS. 2 and 5 denote the same elements, and their description will be omitted.

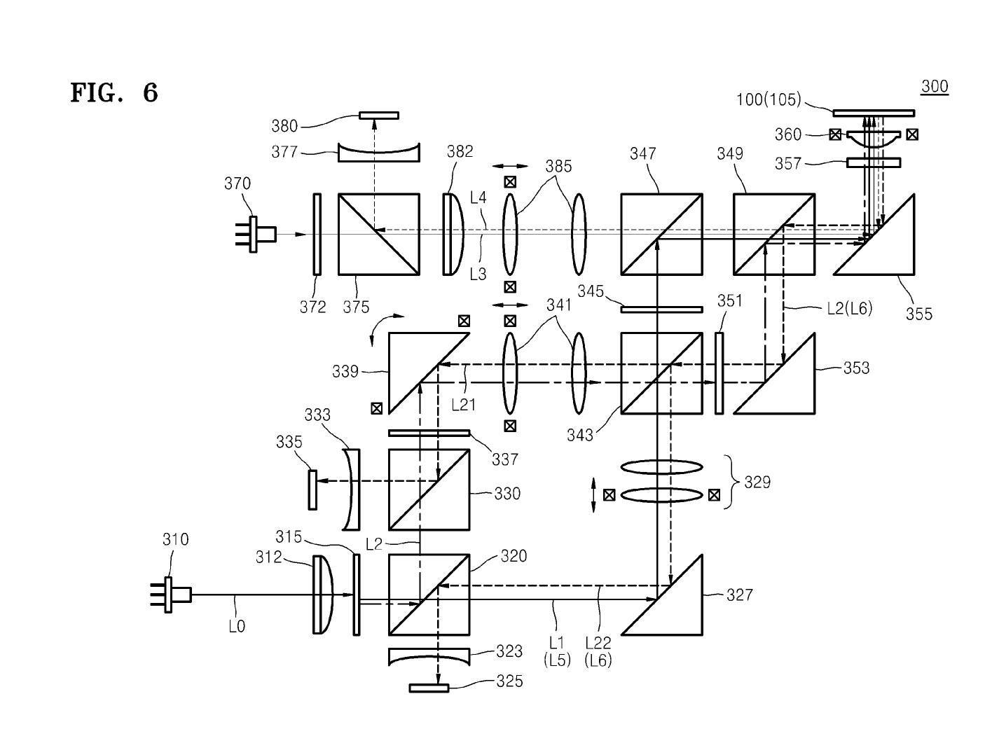

FIG. 6 is a structural view of a holographic data recording/reproducing apparatus 300 according to an aspect of the present invention. Referring to FIG. 6, the holographic data recording/reproducing apparatus 300 records data to the holographic data storage medium 100 (105), and reproduces the recorded data from the holographic data storage medium 100 (105). The holographic data recording/reproducing apparatus 300 includes an optical system of an optical pickup to emit light to a single surface of the holographic data storage medium 100 and to receive the emitted light, and a circuit unit (not shown).

The optical pickup of the holographic data recording/reproducing apparatus 300 may include a first light source 310, a first collimating lens 312, a polarization conversion element 315, a first polarization beam splitter 320, a detecting lens 323, a first photodetector 325, a first mirror 327, a first focus controlling unit 329, a second polarization beam splitter 330, an astigmatism lens 333, a second photodetector 335, a first polarization element 337, a movable mirror 339, a second focus controlling unit 341, a third polarization beam splitter 343, a wave-selective beam splitter 347, a fourth polarization beam splitter 349, a second polarization element 351, second and third mirrors 353 and 355, a quarter wave plate 357, and an objective lens 360. Furthermore, in order to read servo information, the optical pickup of the holographic data recording/reproducing apparatus 300 may further include a servo optical system including a second light source 370, a grating 372, a servo beam polarization beam splitter 375, a second collimating lens 382, a servo beam focus controlling unit 385, a detecting lens 377, and a servo beam detector 380.

In FIG. 6, a thick solid line denotes a reference beam L1 or a reproduction beam L5 emitted from the first light source 310 towards the holographic data storage medium 100 (105). A thick dashed-dotted line denotes a signal beam L2 emitted from the first light source 310 towards the holographic data storage medium 100 (105). In addition, a thick dotted line denotes a signal beam L21 or L22, which is reflected by the holographic data storage medium 100 (105) to proceed towards the first and second photodetectors 325 and 335, or a reproduction beam L6 that is reflected. In the meantime, a thin solid line denotes a servo beam L3 emitted from the second light source 370 towards the holographic data storage medium 100 (105). A thin dotted line denotes a servo beam L4 that is reflected by the holographic data storage medium 100 (105) to proceed towards the servo beam detector 380.

The first light source 310, the first collimating lens 312 and the polarization conversion element 315 constitute a first light source unit that emits the reference beam L1 and the signal beam L2 in a recording mode and emits the reproduction beam L5 in a reproduction mode. The first light source 310 emits a recording/reproducing beam L0 having a linear polarization beam polarized in a predetermined direction. For example, a semiconductor laser diode to emit a blue light beam is used as the first light source 310. The recording/reproducing beam L0 is modulated according to data to be recorded and is emitted from the first light source 310, in the recording mode, and is not modulated and is emitted from the first light source 310, in the reproduction mode. The first collimating lens 312 can change the recording/reproducing beam L0 emitted from the first light source 310 into a parallel light beam.

The polarization conversion element 315 is an active device that functions as a wave plate in the recording mode, and not as a wave plate in the reproduction mode. For example, the polarization conversion element 315 converts a P polarization beam emitted from the first light source 310 into a light beam having P and S polarization components, and transmits a light beam emitted from the first light source 310. Likewise, the P and the S polarization components correspond to the reference beam L1 and the signal beam L2, respectively, in the recording mode.

For example, the polarization conversion element 315 is a rotatable half wave plate of which a polarization axis is mechanically rotated via an external driving power, or an active half wave plate that is switched on and off depending on polarization conversion. For example, the rotatable half wave plate is driven to rotate so that an angle between an optical axis (i.e., a fast axis) of the rotatable half wave plate and the linear polarization direction of an incident light beam may be 22.5 degrees in the recording mode, and the optical axis matches the linear polarization direction of the incident light beam in the reproduction mode. The strengths of a reference beam and a signal beam can be controlled according to the angle between the optical axis and the polarization direction of the incident light beam. The active half wave plate is a liquid crystal device using a birefringence characteristic of its liquid crystal. For example, when a voltage is applied to the active half wave plate, an angle between the linear polarization direction of an incident light beam and the fast axis of the active half wave plate may be 22.5 degrees.

The first polarization beam splitter 320, the first and second focus controlling units 329 and 341, the first mirror 327, and the movable mirror 339 guide the reference beam L1 and the signal beam L2 emitted from the first light source unit in order for the reference beam L1 and the signal beam L2 to pass along optical paths different from each other so that the reference beam L1 and the signal beam L2 cross each other. The first polarization beam splitter 320 transmits and reflects a light beam according to its polarization direction. For example, the first polarization beam splitter 320 can transmit a P polarization beam, and reflect an S polarization beam. Thus, in the recording mode, the first polarization beam splitter 320 transmits the reference beam L1 of the P polarization beam and reflects the signal beam L2 of the S polarization beam, and thus, the optical paths of the reference beam L1 and the signal beam L2 can be separated from each other. In addition, in the reproduction mode, the first polarization beam splitter 320 can separate the reproduction beam L5 emitted to the holographic data storage medium 100 (105) and the reproduction beam L6 reflected by the holographic data storage medium 100 (105).

The second polarization beam splitter 330 is an optical member to separate the signal beam L2 emitted to the holographic data storage medium 100 (105) and a signal beam L21 reflected by the holographic data storage medium 100 (105). In this aspect, when the signal beam L2 has an S polarization, the first polarization beam splitter 320 reflects the signal beam L2, and the second polarization beam splitter 330 transmits the signal beam L2.

The astigmatism lens 333 is a member causing astigmatism with respect to the signal beam L21 separated by the second polarization beam splitter 330. For example, the astigmatism lens 333 may be configured as a combination of a spherical convex lens and a cylinder lens. The astigmatism lens 333 forms a light spot without aberration on the second photodetector 335 when the signal beam L21 is reflected on an in-focus position of the holographic data storage medium 100 (105), and forms a light spot with astigmatism on the second photodetector 335 when the signal beam L21 is reflected on an out-of-focus position in the holographic data storage medium 100 (105).

The second photodetector 335 detects the signal beam L21 that is reflected at least one time between the first and second reflective layers 120 and 140 (refer to FIG. 1) of the holographic data storage medium 100 (105). For example, a quad-photodiode detector is used as the second photodetector 335. A focus error signal is obtained from the signal beam L21 detected by the second photodetector 335.

The first polarization element 337 changes the polarization direction of an incident light beam into a polarization direction orthogonal thereto. For example, a half wave plate is used as the first polarization element 337. The first polarization element 337 may be disposed on an optical path of the signal beam L2 between the second polarization beam splitter 330 and the third polarization beam splitter 343. When a half wave plate is used as the first polarization element 337, the half wave plate is disposed so that an angle between an optical axis of the half wave plate and the polarization direction of the signal beam L21 passing along the optical axis of the half wave plate slightly deviates from 45 degrees. In this case, specific polarization components of the signal beam L21 are almost entirely changed into polarization components that are orthogonal to the specific polarization components of the signal beam L21, and a part of the specific polarization components of the signal L21 is not changed. For example, when an S polarization beam passes through the first polarization element 337, the S polarization beam is changed into a light beam having mainly a P polarization component and partly an S polarization component. On the other hand, when a P polarization beam passes through the first polarization element 337, the P polarization beam is changed into a light beam having mainly an S polarization component and partly a P polarization component. Accordingly, a part of the polarization components of the signal beam L21 passing though the third polarization beam splitter 343 can be reflected by the second polarization beam splitter 330, so as to be detected by the second photodetector 335.

The first mirror 327 and the movable mirror 339 are examples of an optical path conversion element, and are arranged so that optical paths of the separated reference beam L1 and the signal beam L2 cross each other. In particular, the movable mirror 339 is a member that can two-dimensionally and precisely rotate, and can correct a focus of the signal beam L2 in response to movement, such as, a tilt, of the holographic data storage medium 100 (105), or the like.

The first and second focus controlling units 329 and 341 are arranged on the separated optical paths of the reference beam L1 and the signal beam L2, respectively. The first focus controlling unit 329 changes a focus of the reference beam L1 in the objective lens 360 so that a focus (F1 of FIG. 2) of the reference beam L1 varies in the depth direction of the holographic data storage medium 100 (105). Likewise, the second focus controlling unit 341 changes a focus of the signal beam L2 in the objective lens 360 so that a focus F1 of the signal beam L2 varies in the depth direction of the holographic data storage medium 100 (105). Thus, the signal beam L2 is reflected by the second reflective layer (140 of FIG. 1) in the holographic data storage medium 100 (105), and then is focused on the same point as the focus F1 of the reference beam L1. The focal distance of the signal beam L2 in the objective lens 360 is greater than that of the reference beam L1 in the objective lens 360. That is, the first and second focus controlling units 329 and 341 control the convergence/divergence of the reference beam L1 and the signal beam L2 so as to control a numerical aperture, a focal distance, and the like, of an optical system, together with the objective lens 360.

Likewise, when the reference beam L1 and the signal beam L2 are focused on different points in a depth direction of the holographic data storage medium 100 (105), a plurality of information layers are formed to be multi-layers of the holographic recording layer 160. An active relay lens unit may be used as the first and second focus controlling units 329 and 341. For example, the active relay lens unit includes a plurality of lenses such that at least one of the lenses is disposed so as to be movable along an optical axis and is driven by a driving unit.

The third and fourth polarization beam splitters 343 and 349, the wave-selective beam splitter 347, the second polarization element 351 and the second mirror 353 guide the reference beam L1 and the signal beam L2, which cross each other, towards the objective lens 360. For example, the third polarization beam splitter 343 transmits a P polarization beam and reflects an S polarization beam. Thus, the third polarization beam splitter 343 almost entirely transmits polarization components of the signal beam L2 that are converted by the first polarization element 337. On the other hand, as described below, a part of the signal beam L2 reflected by the holographic data storage medium 100 (105) or the reproduction beam L6 reflected in the reproduction mode is reflected by the third polarization beam splitter 343, and then passes back along the optical path of the reference beam L1, to proceed towards the first polarization beam splitter 320.

A shutter 345 is a member that is switched on and off by an external signal so as to block or transmit a light beam. In addition, when only a signal beam is to be emitted to an information layer in order to distinguish the information layers, on which data is to be recorded in the recording mode, the shutter 345 can block a reference beam. Of course, the shutter 345 is opened during recording and reproducing of data. At this time, the distinguishing of the information layers can also be performed.

The wave-selective beam splitter 347 functions as a simple mirror with respect to a wave of the first light source 310, that is, the reference beam L1, and functions as a dichroic mirror that transmits a wave of the second light source 370, that is, the servo beam L3, as will be described below. The wave-selective beam splitter 347 can combine the optical paths of the reference beam L1 and the servo beam L3 that are incident on the holographic data storage medium 100 (105). The wave-selective beam splitter 347 and the second mirror 353 change the optical paths of the reference beam L1 and the signal beam L2 so that the reference beam L1 and the signal beam L2 intersect again, wherein the reference beam L1 and the signal beam L2 pass through the third polarization beam splitter 343 to cross each other at the third polarization beam splitter 343.

The fourth polarization beam splitter 349 functions as a polarization beam splitter with respect to waves of the reference beam L1 and the signal beam L2, and is transparent with respect to servo beams L3 and L4. That is, the fourth polarization beam splitter 349 is a wave-selective optical device. Accordingly, the optical paths of the reference beam L1 and the signal beam L2 are combined to proceed towards the objective lens 360, wherein the reference beam L1 and the signal beam L2 meet at the fourth polarization beam splitter 349. In addition, as described below, the servo beams L3 and L4 are transmitted through the fourth polarization beam splitter 349 without their optical paths being changed.

For example, the second polarization element 351 may be an active plate such as an active half wave plate. The second polarization element 351 functions as a wave plate in the recording mode, but transmits a light beam without converting its polarization. The second polarization element 351 is disposed between the third polarization beam splitter 343 and the fourth polarization beam splitter 349. As described below, in order to detect a part of the signal beam L2 that is reflected by the holographic data storage medium 100 (105), the second polarization element 351 does not completely convert a predetermined linear polarization beam into another linear polarization beam that is orthogonal thereto in the recording mode, and thus, a part of the components of the predetermined linear polarization beam is not converted. For example, when an active half wave plate is used as the second polarization element 351, if an angle between the linear polarization direction of an incident light beam and a fast axis of the active half wave plate is 28.5 degrees, an incident light beam (e.g., an S polarization beam) passes through the active half wave plate so that the polarization direction of the incident light beam rotates. Thus, the incident light beam, that is, the S polarization beam, is converted into a light beam having mainly a P polarization component and partly an S polarization component.

The third mirror 355 changes the optical paths of the reference beam L1 and the signal beam L2 so that the reference beam L1 and the signal beam L2 proceed towards the objective lens 360, wherein the reference beam L1 and the signal beam L2 are combined at the fourth polarization beam splitter 349. The quarter wave plate 357 functions as a wave plate with respect to both of the first light source 310 and the second light source 370. The quarter wave plate 357 can separate light beams incident on and reflected by the holographic data storage medium 100 (105), according to their polarization directions.

The objective lens 360 is a lens to focus the reference beam L1 and the signal beam L2, the reproduction beam L5 or the servo beam L3, which are used for recording/reproducing data, on a predetermined region of the holographic data storage medium 100 (105). As described above, the objective lens 360 changes the focus F1 of the reference beam L1 and the signal beam L2 in the holographic data storage medium 100 (105), via the first and second focus controlling units 329 and 341. Furthermore, the objective lens 360 can change the numerical aperture of the optical system. The objective lens 360 guides the reference beam L1 and the signal beam L2 to be incident on the holographic data storage medium 100 (105). Thus, the reference beam L1 is directly focused on the focus (F1 of FIG. 2) in the holographic data storage medium 100 (105), and the signal beam L2 is reflected by the second reflective layer (140 of FIG. 2) of the holographic data storage medium 100 (105) so as to be focused on the same location as the focus F1 of the reference beam L1. Furthermore, as described below, the objective lens 360 guides the servo beam L3 to be focused on the servo layer 170 (refer to FIG. 5) of the holographic data storage medium 105.

Next, a servo optical system as shown in FIG. 6 will now be described with the holographic data storage medium 105 as shown in FIG. 5. As described below, the holographic data storage medium 105 used in a holographic data recording/reproducing apparatus according to one or more aspects of the present invention may include the servo layer (170 of FIG. 5), and the optical pickup may further include an optical system to reproduce servo information recorded to the servo layer 170.

Referring to FIG. 6, the second light source 370 emits the servo beam L3. For example, a semiconductor laser diode to emit a red light beam that is used as the second light source 370. The servo beam L3 may be a linear polarization beam polarized in a predetermined direction such that the servo beam L3, emitted from the servo beam polarization beam splitter 375 so as to be incident on the holographic data storage medium 105, and the servo beam L4, reflected by the holographic data storage medium 105, can be separated according to their polarization directions. The grating 372 is an optical member to diffract the servo beam L3 emitted from the second light source 370 into 0-th order diffraction light, ±1-st order diffraction light and the like, and can detect a servo error signal by using a push-pull method or the like.

The second collimating lens 382 is a lens to change the servo beam L3 emitted from the second light source 370 into a parallel light beam. The servo beam polarization beam splitter 375 is, for example, a polarization beam splitter, and separates the servo beam L3 incident on the holographic data storage medium 105 and the servo beam L4 reflected by the holographic data storage medium 105 according to their polarization directions. The servo beam focus controlling unit 385 varies the focus of the servo beam L3 in a depth direction of the holographic data storage medium 105, and may be a relay lens unit disposed so that at least one lens included in the relay lens unit is movable along an optical axis.

The detecting lens 377 guides the servo beam L4 so that a light spot of the servo beam L4 is appropriately focused on the servo beam detector 380. For example, the detecting lens 377 is an astigmatism lens that can detect a focus error signal by using an astigmatic method. The servo beam detector 380 includes a plurality of photodetectors to detect servo information and a servo error signal of the servo layer 170 (refer to FIG. 5) of the holographic data storage medium 105. The above-described servo optical system is an example optical system, and thus, aspects of the present invention are not limited thereto.

Next, the holographic data recording/reproducing apparatus according to one or more aspects of the present invention is operated as follows. For convenience of description, when a specific polarization direction is to be described, the linear polarization direction of the recording/reproducing beam L0 emitted from the first light source 310 is assumed to be a P polarization direction.

In the recording mode, the signal beam L2 is emitted to the holographic data storage medium 100 (105) in order to distinguish between information layers on which data is to be recorded. To achieve this, the first light source 310 emits the recording/reproducing beam L0 as a P polarization beam. The polarization conversion element 315 converts the emitted recording/reproducing beam L0 into the reference beam L1 having a P polarization and the signal beam L2 having an S polarization. The first polarization beam splitter 320 separates the reference beam L1 and the signal beam L2.

The reference beam L1 as the P polarization beam passes through the first focus controlling unit 329, and then passes through the third polarization beam splitter 343, the wave-selective beam splitter 347 and the fourth polarization beam splitter 349 so as to be incident on the objective lens 360. The signal beam L2 as the S polarization beam passes through the second polarization beam splitter 330, the first polarization element 337, the second focus controlling unit 341, the third polarization beam splitter 343, the second polarization element 351 and the fourth polarization beam splitter 349 so as to be incident on the objective lens 360. The reference beam L1 incident on the objective lens 360 is directly focused in the holographic recording layer 160 of the holographic data storage medium 100 (105).

The signal beam L2 incident on the objective lens 360 is almost entirely reflected by the second reflective layer 140 so as to be focused on a focus (F1 of FIG. 2) of the reference beam L1. The holographic recording layer (160 of FIG. 2) is locally optical-deformed by the reference beam L1 and the signal beam L2 that are focused, and thus, recording can be performed. A part of the signal beam L2 that is incident on the objective lens 360 is transmitted through the second reflective layer (140 of FIG. 2) to be repeatedly reflected between the first and second reflective layers 120 and 140. In this case, the focus F2 of a part of the signal beam L2 transmitted through the second reflective layer 140 is formed on the first reflective layer 120 or the second reflective layer 140, and the focus F2 formed on the first reflective layer 120 or the second reflective layer 140 is in mirror symmetry with the focus F1 formed in the holographic recording layer 160.

The signal beam L2, which is reflected at least one time between the first and second reflective layers 120 and 140, passes back through the second reflective layer 140 to be incident back on the optical pickup. When the first and second reflective layers 120 and 140 are formed of cholesteric liquid crystal, the signal beam L2 incident back on the objective lens 360 maintains the circular polarization state of the signal beam L2, wherein the circular polarization state is at a point of time when the signal beam L2 is incident on the holographic data storage medium 100 (105). In this case, since the signal beam L2 incident back on the objective lens 360 is maintained to have an S polarization beam, the signal beam L2 is reflected by the fourth polarization beam splitter 349. In addition, the signal beam L2 is almost entirely converted into a P polarization beam by the second polarization element 351, and only a part of the signal beam L2 is not converted so as to be an S polarization beam.

The signal beam L21 converted mostly into a P polarization beam by the second polarization element 351 passes through the third polarization beam splitter 343 so as to be incident on the first polarization element 337. The signal beam L2 that is incident back on the first polarization element 337 is almost entirely converted into an S polarization beam. However, a part of the signal beam L21 is maintained as a P polarization beam, and is reflected by the second polarization beam splitter 330. The part of the signal beam L21, which is reflected by the second polarization beam splitter 330, is detected by the second photodetector 335. Since the signal beam L2 is reflected at least one time between the first and second reflective layers 120 and 140 of the holographic data storage medium 100 (105), the signal beam L21 contains information regarding a focus location. Thus, each information layer (160a of FIG. 2) can be distinguished from each other by detecting the signal beam L21.

Holographic information storage media having various forms, and a method and apparatus for recording/reproducing data by using the holographic information storage medium have been particularly shown and described with regard to the above aspect of the invention. According to the above aspects, at least two reflective layers are provided so as to distinguish between a plurality of information layers in a holographic recording layer, and thus, each information layer can be distinguished from each other by detecting light reflected by the reflective layers.

In aspects of the present invention, reference to a polarization beam, such as a circular polarization beam, also refers to a polarized beam, such as a circular polarized beam.

In various aspects, and/or refers to alternatives chosen from available elements so as to include one or more of the elements. For example, if the elements available include elements X, Y, and Z, and/or refers to X, Y, Z, or any combination thereof. Additionally, recording/reproducing apparatus refers to a recording and/or a reproducing apparatus.

In the figures, the dimensions of layers and regions may be exaggerated for clarity. It will also be understood that when a layer or element is referred to as being “on” or “over” another layer or substrate, it can be directly on the other layer or substrate, or intervening layers may also be present. Further, it will be understood that when a layer is referred to as being “under” or “below” another layer, it can be directly under, or one or more intervening layers may also be present.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A holographic data storage medium comprising:
a substrate;
a manifold reflective layer between which a first part of a signal beam is capable of being reflected at least one time and then being emitted from the manifold reflective layer; and
a holographic recording layer in which a plurality of information layers are capable of being formed in a depth direction of the holographic recording layer, wherein interference patterns of a reference beam and a second part of the signal beam constitute each of the plurality of information layers.

2. The medium of claim 1, wherein the manifold reflective layer comprises:
a first reflective layer disposed on the substrate;
a space layer disposed on the first reflective layer; and
a second reflective layer disposed on the space layer.

3. The medium of claim 2, wherein the first and second reflective layers are each a polarization-dependent reflective layer to reflect a light beam of a first polarization component and to transmit a light beam of a second polarization component, wherein the first and second polarization components are orthogonal to each other.

4. The medium of claim 3, wherein the first and second polarization components are circular polarization components that are orthogonal to each other, and the first and second reflective layers are each a circular polarization reflective layer to maintain a polarization direction of a reflected circular polarization beam.

5. The medium of claim 3, wherein the first and second polarization components are circular polarization components that are orthogonal to each other, and the first and second reflective layers are each a circular polarization reflective layer to change a polarization direction of a reflected circular polarization beam.

6. The medium of claim 2, wherein an interval between the first and second reflective layers is smaller than ½ of the thickness of the holographic recording layer.

7. The medium of claim 1, further comprising a servo layer to which servo information is recorded.

8. The medium of claim 1, wherein information recorded in the form of the interference patterns is recorded in units of a single bit.

9. An apparatus to record/reproduce holographic data in a holographic data storage medium including a substrate, a manifold reflective layer between which a first part of a signal beam is capable of being reflected at least one time and then being emitted from the manifold reflective layer, and a holographic recording layer in which a plurality of information layers are capable of being formed in a depth direction of the holographic recording layer, wherein interference patterns of a reference beam and a second part of the signal beam constitute each of the plurality of information layers, the apparatus comprising:
an optical pickup to detect a signal of the signal beam that is incident on the holographic data storage medium, and is reflected in the manifold reflective layer in order to be emitted from the holographic storage medium,
wherein the apparatus detects respective locations of the plurality of information layers from the signal detected by the optical pickup.

10. The apparatus of claim 9, wherein the optical pickup comprises:
a first light source unit to emit the reference beam and the signal beam;
a optical path guide unit to guide the reference beam and the signal beam emitted from the first light source in order for the reference beam and the signal beam to pass along different optical paths so that the reference beam and the signal beam combine with each other to produce the interference patterns;
an objective lens to illuminate the reference beam and the signal beam that passes through the optical path guide unit onto a signal surface of the holographic data storage medium; and
a signal beam detecting unit to detect the signal beam reflected by the holographic data storage medium.

11. The apparatus of claim 10, wherein the first light source unit emits the reference beam and the signal beam as linear polarization beams that are orthogonal to each other, and the signal beam detecting unit comprises:
a polarization element disposed on an optical path of the signal beam that is reflected by the holographic data storage medium and to convert the signal beam that passes through the polarization element so that the signal beam partly includes a second polarization component, wherein the second polarization component is orthogonal to a first polarization component of the signal beam;
a polarization beam splitter to separate the signal beam that passes through the polarization element according to the respective first and second polarization components; and
a signal beam detector to detect the signal beam that is separated by the polarization beam splitter.

12. The apparatus of claim 11, wherein the polarization element is a half wave plate.

13. The apparatus of claim 11, wherein the first light source unit comprises:
a first light source; and
an active polarization conversion element to convert a light beam that passes through the active polarization conversion element so that the light beam has linear polarization beams orthogonal to each other in a recording mode and the light beam is the same polarization beam as that of the reference beam in a reproduction mode.

14. The apparatus of claim 10, further comprising first and second focus controlling units disposed on the different optical paths of the reference beam and the signal beam so as to be between the first light source unit and the objective lens, respectively, and to control focal distances of the reference beam and the signal beam that are emitted on the holographic data storage medium.

15. The apparatus of claim 14, wherein the first and second focus control units are each an active relay lens unit that is driven so that at least one lens is movable along an optical path.

16. The apparatus of claim 10, further comprising a reproducing beam detecting unit to detect a reproducing beam reflected by the holographic data storage medium.

17. The apparatus of claim 10, wherein the optical pickup further comprises a servo optical system so as to correctly follow a recording location in the holographic data storage medium.

18. The apparatus of claim 17, wherein the servo optical system comprises:
a second light source unit to emit a servo beam having a different wavelength from that of a light beam used to generate the reference beam and the signal beam, and emitted from the first light source unit, and having a linear polarization beam;
a servo beam polarization beam splitter to separate the servo beam emitted from the second light source and the servo beam reflected by the holographic data storage medium into light beams having different optical paths; and
a servo beam detector to detect the servo beam reflected by the holographic data storage medium to be separated by the servo beam polarization beam splitter.

19. The apparatus of claim 9, wherein information recorded in the form of the interference patterns is recorded in units of a single bit.

20. A method of recording/reproducing holographic data by using a holographic data storage medium including a substrate, a manifold reflective layer between which a first part of a signal beam is capable of being reflected at least one time and then being emitted from the manifold reflective layers, and a holographic recording layer in which a plurality of information layers are capable of being formed in a depth direction of the holographic recording layer, wherein interference patterns of a reference beam and a second part of the signal beam constitute each of the plurality of information layers, the method comprising:
detecting respective locations of the plurality of information layers from a signal of a signal beam that is incident on the holographic data storage medium and is reflected in the manifold reflective layers so as to be emitted from the holographic storage medium.

21. The medium of claim 1, wherein the plurality of information layers are capable of being formed in the depth direction of the holographic recording layer according to respective number of times the signal beam is reflected in the manifold reflective layer.

22. The medium of claim 1, wherein the manifold reflective layer includes at least two reflective layers to distinguish between the plurality of information layers in the holographic recording layer by detecting the reflected first part of the signal beam.

23. The medium of claim 2, wherein the first part of the signal beam is reflected at least one time between the first and second reflective layers, and contains information regarding a focus location within the holographic recording layer.

24. A holographic data storage medium for use with a holographic recording/reproducing apparatus, the medium comprising:
a substrate;
a first reflective layer to reflect and to transit components of a light beam according to corresponding polarizations of the components of the light beam, and formed over the substrate;
a second reflective layer to reflect the transmitted component of the light beam, and formed on the substrate;
a space layer to transmit the transmitted component of the light beam, and formed between the first and second reflective layers; and
a holographic recording layer capable of being formed into a plurality of information layers containing interference patterns based on the reflected component of the light beam, and formed on the second reflective layer, wherein the plurality of information layers are generated in a depth direction of the holographic recording layer based on a detected strength of the transmitted component of the light beam.
